(19) United States
(12) Patent Application Publication
(10) Pub. No.: US 2025/0101163 A1
(43) Pub. Date: Mar. 27, 2025

(54) DAMPING ANTI-FATIGUE AGING CARBON DIOXIDE-BASED POLYURETHANE ELASTOMER AND PREPARATION METHOD THEREOF

(71) Applicants: HEBEI TIEKE YICHEN NEW MATERIALS TECHNOLOGY CORPORATION LIMITED, Shijiazhuang, Hebei (CN); RAILWAY ENGINEERING RESEARCH INSTITUTE, CHINA ACADEMY OF RAILWAY SCIENCES CORPORATION LIMITED, Beijing (CN); BEIJING TIEKESHOUGANG RAILWAY TECHNOLOGY CORPORATION LIMITED, Beijing (CN)

(72) Inventors: Quanxiao Dong, Shijiazhuang, Hebei (CN); Peng Qiu, Shijiazhuang, Hebei (CN); Xueliang Cui, Shijiazhuang, Hebei (CN); Yubao Guo, Shijiazhuang, Hebei (CN); Xingxu Bao, Shijiazhuang, Hebei (CN); Songran Liu, Shijiazhuang, Hebei (CN); Ruixue Niu, Shijiazhuang, Hebei (CN); Simeng Yan, Shijiazhuang, Hebei (CN); Yitong Shen, Shijiazhuang, Hebei (CN); Huihui Xu, Shijiazhuang, Hebei (CN); Songqi Zhang, Beijing (CN); Yuanqing Zhang, Beijing (CN); Junheng Xiao, Beijing (CN); Xianhong Wang, Shijiazhuang, Hebei (CN); Hongming Zhang, Shijiazhuang, Hebei (CN); Haitao Liu, Beijing (CN); Weibin Liu, Beijing (CN); Fengxiang Gao, Shijiazhuang, Hebei (CN); Yanlei Dong, Shijiazhuang, Hebei (CN); Zirui Li, Beijing (CN); Huan Zhang, Beijing (CN); Yanshan Li, Beijing (CN); Chengliang Li, Beijing (CN); Minxiao Zhang, Shijiazhuang, Hebei (CN); Tiantian Song, Shijiazhuang, Hebei (CN); Zhi Liu, Beijing (CN); Yongwang Wei, Beijing (CN); Xiaoru Liu, Shijiazhuang, Hebei (CN); Linheng Bao, Shijiazhuang, Hebei (CN); Lifen Li, Shijiazhuang, Hebei (CN); Ruolin Jiang, Shijiazhuang, Hebei (CN); Xiaozhao Yu, Shijiazhuang, Hebei (CN); Cheng Qiu, Shijiazhuang, Hebei (CN); Li Zhang, Shijiazhuang, Hebei (CN); Kuan Liu, Shijiazhuang, Hebei (CN); Yuqing Wen, Shijiazhuang, Hebei (CN); Hang Zhao, Shijiazhuang, Hebei (CN); Liting Dong, Shijiazhuang, Hebei (CN); Qiang Zhao, Shijiazhuang, Hebei (CN); Ning Zhang, Shijiazhuang, Hebei (CN); Hongsong Guan, Shijiazhuang, Hebei (CN); Ling Gao, Shijiazhuang, Hebei (CN); Huitong Pei, Shijiazhuang, Hebei (CN)

(21) Appl. No.: 18/852,484

(22) PCT Filed: Nov. 8, 2023
(86) PCT No.: PCT/CN2023/130460

§ 371 Date: Sep. 29, 2024

(30) Foreign Application Priority Data
Dec. 8, 2022 (CN) 202211570135.2

(51) Int. Cl. C08G 18/32; C08G 18/46

(52) U.S. Cl. CPC C08G 18/3206; C08G 18/4684

(57) ABSTRACT

The invention provides a carbon dioxide-based polyurethane elastomer with damping and anti-fatigue aging properties and its preparation method. It is obtained from Component A and Component B; Component A includes: PTMG-1000 45˜60 parts, carbon dioxide-based polyol 25˜30 parts, poly-DOPO-ITA-pentanediol ester 10˜20 parts, BDO 3˜5 parts, water 0.3˜0.5 parts, N-methylimidazole 0.5˜0.8 parts, bis(2-dimethylaminoethyl) ether 0.1˜0.2 parts, needle-shaped nano-titanium dioxide 0.5 parts, hindered phenol 0.2˜0.5 parts, dibutyltin dilaurate 0.1˜0.3 parts, strontium chloride 0.005˜0.01 parts, rhodium chloride 0.02˜0.03 parts, foaming agent 0.2˜0.5 parts; Component B includes: carbon dioxide-based polyol 50˜55 parts, MDI-50 45˜50 parts, organic zinc 0.01˜0.02 parts, organic bismuth 0.01˜0.02 parts.

### TECHNICAL FIELD

The present invention relates to the field of polymer elastomer technology, particularly to a damping anti-fatigue aging carbon dioxide-based polyurethane elastomer and its preparation method.

### BACKGROUND ART

Polyurethane elastomers are commonly used to make clastic pads, which contain micrometer-scale pores. When applied in high-speed railway fasteners, they can reduce the vibration and shock produced during train operation, decrease the compressive stress on the track bed and subgrade, reduce deformation and damage to the track bed, and protect the track bed.

In related technologies, the performance of the elastic pads is often ensured by adjusting the raw materials of the polyurethane elastomer. For example, Chinese patent document CN102161790A discloses a thermoplastic elastomer for subways, light rails, and shock-absorbing pads, which, by adding plasticized sulfurized rubber, mineral oil, barium sulfate, 1,2-polybutadiene polymer, polypropylene, and hydrogenated styrene-butadiene elastomer, provides the product with high pressure resistance, acid and alkali resistance, and good shock absorption.

Chinese patent document CN1092210C provides a high abrasion-resistant polyurethane elastomer obtained by reacting amino-modified polyisocyanate with polyester polyol or polyether polyol in the presence of liquid polybutadiene (at room temperature 25° C.).

Its abrasion resistance is characterized by material wear of less than 300 milligrams (determined according to ISO 4649 experimental method A).

However, during use, due to fatigue loading, it is easy for the internal microstructure and pores of the polyurethane elastomer pads to be damaged, leading to reduced performance of the pads and weakened damping properties, which severely restricts the service life of the rubber pads. The aforementioned raw material adjustment schemes do not consider adjusting the microstructure and pores of the polyurethane elastomer to endow the final pads with damping anti-fatigue aging properties and improve application performance. Therefore, there is an urgent need to provide a new technical solution to solve the above problems.

### SUMMARY OF THE INVENTION

The technical problem to be solved by the present invention is to provide a damping anti-fatigue aging carbon dioxide-based polyurethane elastomer and its preparation method.

To solve the above problems, the technical solution adopted by the present invention is:

On one hand, a damping anti-fatigue aging carbon dioxide-based polyurethane elastomer is provided, which is obtained by mixing component A and component B in a mass ratio of 1:(0.95-1.10);

Component A, by mass parts, includes: PTMG-1000 45˜60 parts, carbon dioxide-based polyol 25˜30 parts, poly-DOPO-ITA-pentanediol ester 10˜20 parts, BDO 3˜5 parts, water 0.3˜0.5 parts, N-methylimidazole 0.5˜0.8 parts, bis(2-dimethylaminoethyl) ether 0.1˜0.2 parts, needle-like nano-titanium dioxide 0.5 parts, carboxyl-terminated hindered phenol 0.2˜0.5 parts, dibutyltin dilaurate 0.1˜0.3 parts, strontium chloride 0.005˜0.01 parts, rhodium chloride 0.02˜0.03 parts, foam uniforming agent 0.2˜0.5 parts;

Component B, by mass parts, includes: prepolymer, organic zinc, and organic bismuth, wherein the prepolymer is obtained by reacting 50˜55 parts of carbon dioxide-based polyol with 45˜50 parts of MDI-50 at 80° C. for 2˜3 hours, organic zinc 0.01˜0.02 parts, organic bismuth 0.01˜0.02 parts.

As an embodiment of the invention, the molecular weight of the carbon dioxide-based polyol in components A and B is 2000˜3000, with a functionality of 2.

As an embodiment of the invention, the reaction equation for the poly-DOPO-ITA-pentanediol ester in component A is as follows:

### First Step Chemical Equation

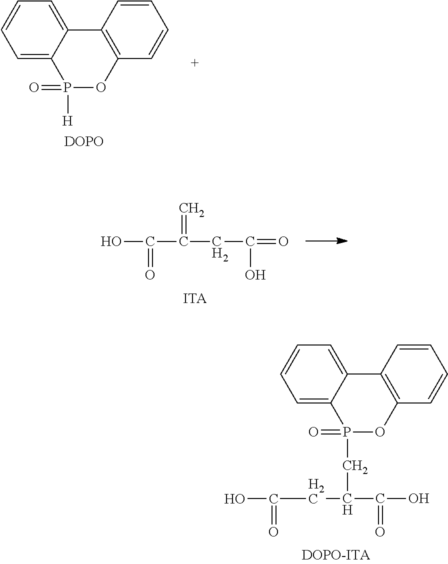

### Second Step Chemical Equation

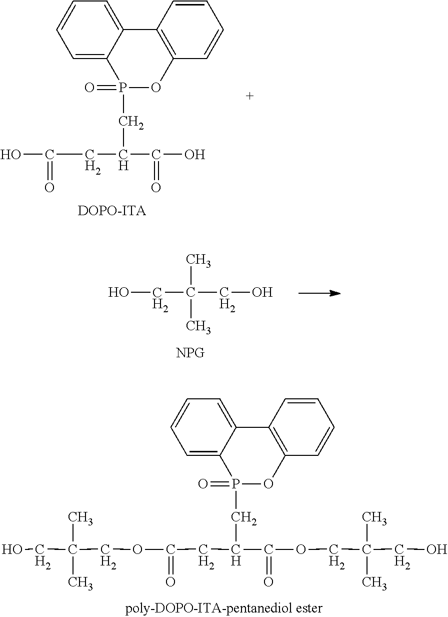

As an embodiment of the invention, it includes the following steps:

(1) DOPO is placed in toluene, heated to 85° C., slowly stirred and dissolved, then itaconic acid (ITA) is added, heated to 110° C., reacted for 7 hours, then cooled to room temperature, filtered to obtain a white solid, which is DOPO-ITA;

(2) DOPO-ITA, solid neopentyl glycol, and liquid NPG containing 10% water are added to the reaction kettle, heated to 100° C. to distill off the water; then, heated to 180° C., reacted for 1.5 hours to complete pre-distillation, then heated to 220° C., reacted for 3 hours to complete the esterification process, to obtain poly-DOPO-ITA-pentanediol ester.

As an embodiment of the invention, in step (1), 21˜22 g of DOPO is placed in 60˜70 mL of toluene, heated to 85° C., slowly stirred and dissolved, then 12˜14 g of itaconic acid is added;

In step (2), 34˜35 g of DOPO-ITA, 10˜11 g of solid neopentyl glycol, and 10˜11 g of liquid neopentyl glycol containing 10% water are added.

As an embodiment of the invention, the diameter of the needle-like nano-titanium dioxide in component A is 10-100 nm, and the length-to-diameter ratio is 30-100.

As an embodiment of the invention, the carboxyl-terminated hindered phenol in component A is selected from any one of 3,5-di-tert-butyl,4-hydroxybenzoic acid, 3,5-di-tert-butyl,4-hydroxyphenylpropionic acid, or 3,5-di-tert-butyl,4-hydroxyphenylvaleric acid.

As an embodiment of the invention, the foam uniforming agent in component A is water-soluble silicone oil.

On the other hand, a preparation method for the damping anti-fatigue aging carbon dioxide-based polyurethane elastomer as described in the first aspect is provided, characterized by including the following steps:

### (1) Preparation of Poly-DOPO-ITA-Pentanediol Ester:

21˜22 g of DOPO is placed in 60˜70 mL of toluene, heated to 85° C., slowly stirred and dissolved, then 12˜14 g of itaconic acid is added, heated to 110° C., reacted for 7 hours, cooled to room temperature, washed with tetrahydrofuran, filtered, and dried with blowing air to obtain DOPO-ITA;

(2) 34˜35 g of DOPO-ITA, 10˜11 g of solid neopentyl glycol (NPG), and 10˜11 g of liquid NPG containing 10% water are added all at once to the reaction kettle, heated to 100° C. to distill off the water; then, the temperature is raised to 180° C. and reacted for 1.5 hours to complete pre-distillation, then heated to 220° C. and reacted for 3 hours to complete the esterification process, obtaining poly-DOPO-ITA-pentanediol ester;

### (2) Preparation of Component A:

By mass parts, 60 parts of PTMG-1000, 25 parts of carbon dioxide-based polyol, 12 parts of poly-DOPO-ITA-pentanediol ester, 3 parts of BDO, 0.4 parts of water, 0.7 parts of N-methylimidazole, 0.1 parts of bis(2-dimethylaminoethyl) ether, 0.5 parts of needle-like nano-titanium dioxide, 0.2 parts of carboxyl-terminated hindered phenol (3,5-di-tert-butyl,4-hydroxybenzoic acid), 0.2 parts of dibutyltin dilaurate, 0.005 parts of strontium chloride, 0.025 parts of rhodium chloride, and 0.5 parts of foam uniforming agent are added to the reaction kettle, stirred evenly to obtain Component A;

### (3) Preparation of Component B:

Under a vacuum of less than 0.06 MPa, 55 parts of carbon dioxide-based polyol are heated to 105° C. for dehydration; after 2 hours of dehydration, 45 parts of MDI-50 are added and reacted at 80° C. for 3 hours to obtain the prepolymer, then 0.02 parts of organic zinc and 0.01 parts of organic bismuth are added to the prepolymer, stirred evenly to obtain Component B;

### (4) Preparation of the Damping Anti-Fatigue Aging Carbon Dioxide-Based Polyurethane Elastomer:

Component A and Component B are separately heated to 40° C. and then mixed in a mass ratio of 1:1, stirred at a speed of 1500˜2000 rpm for 10˜15 seconds, then poured into a mold, and cured in a 65° C. mold for 15 minutes to obtain the said carbon dioxide-based polyurethane elastomer.

The beneficial effects of the technical solution are as follows:
1. The ester bonds in the carbon dioxide-based polyol used are high in energy, making the material itself more stable;
2. The material contains needle-like nanoparticles that can act as heterogeneous nucleating agents, making the material's pores small and uniform, with closed pores, and more resistant to fatigue;
3. This application innovatively provides a method for preparing poly-DOPO-ITA-pentanediol ester, which not only has mild reaction conditions and a simple preparation method but also, after the prepared poly-DOPO-ITA-pentanediol ester is coordinated with carbon dioxide-based polyol, PTMG, and needle-like nanoparticles, regulates the microphase structure of the material, making the material's damping temperature range wider (as known from the AFM image, compared to ordinary PTMG-MDI type polyurethane, the average roughness Sa of the polyurethane elastomer obtained by this application changes from 17 nm to 3 nm, with a higher degree of microphase separation), improves the damping effect, and also improves the anti-aging performance.

### BRIEF DESCRIPTION OF THE DRAWINGS

FIG. 1 is an AFM image of the damping anti-fatigue aging carbon dioxide-based polyurethane elastomer obtained in Example 1.

FIG. 2 is an AFM image of the PTMG-MDI type polyurethane obtained in Comparative Example 6.

FIG. 3 is an SEM image of the damping anti-fatigue aging carbon dioxide-based polyurethane elastomer obtained in Example 1.

### DETAILED DESCRIPTION OF EMBODIMENTS

To make the objectives, technical solutions, and advantages of the present invention clearer, the invention is described in more detail below in conjunction with specific embodiments.

Unless otherwise specified, all kinds of raw materials, reagents, instruments, and equipment used in this invention can be purchased from the market or prepared by existing methods. Among them:
PTMG-1000, Mitsubishi Chemical Corporation, Japan;
PTMG-2000, Mitsubishi Chemical Corporation, Japan;
Carbon dioxide-based polyol (molecular weight 2000-3000, functionality 2): prepared according to the invention patent with publication number CN107868239A;
DOPO, Jiangsu Hanfeng Technology Co., Ltd.;
Itaconic acid (ITA), Zhejiang Guoguang Biochemistry Co., Ltd.;
Neopentyl glycol (NPG), BASF-YPC Neopentylglycol Co., Ltd.;
Tetrahydrofuran (THF), Nanjing Bluestar New Chemical Materials Co., Ltd.;
BDO, Nanjing Bluestar New Chemical Materials Co., Ltd.;
N-methylimidazole, Shandong Yilang Chemical Co., Ltd.;
Bis(2-dimethylaminoethyl) ether, Air Products and Chemicals, Inc., USA;
Needle-like nano-titanium dioxide (diameter of nano-titanium dioxide 10-100 nm, aspect ratio 30-100), Nanjing Haitai Nano Material Co., Ltd.;
Carboxyl-terminated hindered phenol: 3,5-di-tert-butyl,4-hydroxybenzoic acid, 3,5-di-tert-butyl,4-hydroxyphenylpropionic acid, or 3,5-di-tert-butyl,4-hydroxyphenylvaleric acid, Shanghai Haohong Biomedical Technology Co., Ltd.;
Dibutyltin dilaurate (T-12), Air Products and Chemicals, Inc., USA;
Strontium chloride, Anhui Ze Sheng Technology Co., Ltd. (Anhui Ze Sheng Technology Co., Ltd.);
Rhodium chloride, Anhui Ze Sheng Technology Co., Ltd. (Anhui Ze Sheng Technology Co., Ltd.);
Foam uniforming agent: water-soluble silicone oil, produced by Jiangsu Meiside Chemical Co., Ltd., M-8804, M-8842, or M-8843;
In this application, the name for DOPO-ITA is:

[(6-oxo-(6H)-dibenz [c,e][1,2]oxaphosphorin-6-yl)methyl]succinic acid.

### Embodiment 1

### (1) Preparation of Poly-DOPO-ITA-Pentanediol Ester:

21.6 g of DOPO is placed in 65 ml of toluene, heated to 85° C., slowly stirred and dissolved, then 13 g of itaconic acid (ITA) is added, heated to 110° cand reacted for 7 hours. After cooling to room temperature, the reaction mixture is washed with tetrahydrofuran, filtered, and dried with blowing air to obtain a white solid, which is DOPO-ITA.

34.6 g of DOPO-ITA, 10.4 g of solid neopentyl glycol (NPG), and 10.4 g of liquid NPG containing 10% water are added all at once to the reaction kettle, heated to 100° C. to distill off the water. Afterward, the temperature is raised to 180° C. and reacted for 1.5 hours to complete pre-distillation, then heated to 220° C. and reacted for 3 hours to complete the esterification process, obtaining poly-DOPO-ITA-pentanediol ester.

### (2) Preparation of Component A:

By mass parts, 60 parts of PTMG-1000, 25 parts of carbon dioxide-based polyol, 12 parts of poly-DOPO-ITA-pentanediol ester, 3 parts of BDO, 0.4 parts of water, 0.7 parts of N-methylimidazole, 0.1 parts of bis(2-dimethylaminoethyl) ether, 0.5 parts of needle-like nano-titanium dioxide, 0.2 parts of carboxyl-terminated hindered phenol (3,5-di-tert-butyl,4-hydroxybenzoic acid), 0.2 parts of dibutyltin dilaurate, 0.005 parts of strontium chloride, 0.025 parts of rhodium chloride, and 0.5 parts of foam uniforming agent are added to the reaction kettle, stirred evenly to obtain Component A.

### (3) Preparation of Component B:

Under a vacuum of less than 0.06 MPa, 55 parts of carbon dioxide-based polyol are heated to 105° C. for dehydration. After 2 hours of dehydration, 45 parts of MDI-50 are added and reacted at 80° C. for 3 hours to obtain the prepolymer. Then, 0.02 parts of organic zinc and 0.01 parts of organic bismuth are added to the prepolymer, stirred evenly to obtain Component B.

### (4) Preparation of the Damping Anti-Fatigue Aging Carbon Dioxide-Based Polyurethane Elastomer:

Component A and Component B are separately heated to 40° C. and then mixed in a mass ratio of 1:1, stirred at a speed of 1500˜2000 rpm for 10˜15 seconds, then poured into a mold, and cured in a 65° C. mold for 15 minutes to obtain the said carbon dioxide-based polyurethane elastomer.

### Embodiment 2

### (1) Preparation of Poly-DOPO-ITA-Pentanediol Ester:

21 g of DOPO was placed in 60 ml of toluene, heated to 85° C. and slowly stirred until dissolved, then 12.64 g of itaconic acid (ITA) was added, heated to 110° C. and reacted for 7 hours. After cooling the reaction mixture to room temperature, it was washed with tetrahydrofuran, filtered, and dried with blowing air to obtain a white solid, which is DOPO-ITA.

34 g of DOPO-ITA, 10 g of solid neopentyl glycol (NPG), and 10 g of liquid NPG containing 10% water were added to the reaction vessel at once, heated to 100° C. to distill off the water; then, the temperature was raised to 180° C. and reacted for 1.5 hours to complete the pre-distillation, and then raised to 220° C. to react for 3 hours to complete the esterification process, obtaining poly-DOPO-ITA-pentanediol ester.

### (2) Preparation of Component A:

By mass parts, 45 parts of PTMG-1000, 30 parts of carbon dioxide-based polyol, 20 parts of poly-DOPO-ITA-pentanediol ester, 5 parts of BDO, 0.3 parts of water, 0.8 parts of N-methylimidazole, 0.2 parts of bis(dimethylaminoethyl) ether, 0.5 parts of needle-like nano titanium dioxide, 0.5 parts of hindered phenol with carboxyl end group (3,5-di-tert-butyl, 4-hydroxybenzyl propionic acid), 0.1 parts of dibutyltin dilaurate, 0.01 parts of strontium chloride, 0.02 parts of rhodium chloride, and 0.3 parts of foaming agent were added to the reaction vessel, stirred uniformly to obtain Component A.

### (3) Preparation of Component B:

By mass parts, under a vacuum of less than 0.06 MPa, 52 parts of carbon dioxide-based polyol were heated to 105° C. for dehydration; after dehydrating for 2 hours, 48 parts of MDI-50 were added at 80° C. and reacted for 3 hours to obtain a prepolymer, to which 0.015 parts of organic zinc and 0.02 parts of organic bismuth were added, stirred uniformly to obtain Component B.

(4) Preparation of Carbon Dioxide-Based Polyurethane Elastomer with Damping and Anti-Fatigue Aging Resistance:

Component A and Component B were heated to 40° C. separately and then mixed at a mass ratio of 1:0.95. The mixture was stirred at a speed of 1500˜2000 r/min for 10˜15 s and then poured into a mold. It was cured in a 65° C. mold for 12 min to obtain the said carbon dioxide-based polyurethane elastomer.

### Embodiment 3

### (1) Preparation of Poly-DOPO-ITA-Pentanediol Ester:

22 g of DOPO was placed in 70 ml of toluene, heated to 85° C. and slowly stirred until dissolved, then 13.24 g of itaconic acid (ITA) was added, heated to 110° C. and reacted for 7 hours. After cooling the reaction mixture to room temperature, it was washed with tetrahydrofuran, filtered, and dried with blowing air to obtain a white solid, which is DOPO-ITA.

35 g of DOPO-ITA, 10.6 g of solid neopentyl glycol (NPG), and 10.6 g of liquid NPG containing 10% water were added to the reaction vessel at once, heated to 100° C. to distill off the water; then, the temperature was raised to 180° C. and reacted for 1.5 hours to complete the pre-distillation, and then raised to 220° C. to react for 3 hours to complete the esterification process, obtaining poly-DOPO-ITA-pentanediol ester.

### (2) Preparation of Component A:

By mass parts, 58 parts of PTMG-1000, 28 parts of carbon dioxide-based polyol, 10 parts of poly-DOPO-ITA-pentanediol ester, 4 parts of BDO, 0.5 parts of water, 0.5 parts of N-methylimidazole, 0.15 parts of bis(dimethylaminoethyl) ether, 0.5 parts of needle-like nano titanium dioxide, 0.4 parts of hindered phenol with carboxyl end group (3,5-di-tert-butyl, 4-hydroxybenzyl valeric acid), 0.3 parts of dibutyltin dilaurate, 0.007 parts of strontium chloride, 0.03 parts of rhodium chloride, and 0.2 parts of foaming agent were added to the reaction vessel, stirred uniformly to obtain Component A.

### (3) Preparation of Component B:

By mass parts, under a vacuum of less than 0.06 MPa, 50 parts of carbon dioxide-based polyol were heated to 105° C. for dehydration; after dehydrating for 2 hours, 50 parts of MDI-50 were added at 80° C. and reacted for 3 hours to obtain a prepolymer, to which 0.01 parts of organic zinc and 0.015 parts of organic bismuth were added, stirred uniformly to obtain Component B.

(4) Preparation of Carbon Dioxide-Based Polyurethane Elastomer with Damping and Anti-Fatigue Aging Resistance:

Component A and Component B were heated to 40° C. separately and then mixed at a mass ratio of 1:1.1. The mixture was stirred at a speed of 1500˜2000 r/min for 10˜15 s and then poured into a mold. It was cured in a 65° C. mold for 14 min to obtain the said carbon dioxide-based polyurethane elastomer.

### Comparative Example 1

### (1) Preparation of Poly-DOPO-ITA-Pentanediol Ester:

21.6 g of DOPO was placed in 65 ml of toluene, heated to 85° C. and slowly stirred until dissolved, then 13 g of itaconic acid (ITA) was added, heated to 110° C. and reacted for 7 hours. After cooling the reaction mixture to room temperature, it was washed with tetrahydrofuran, filtered, and dried with blowing air to obtain a white solid, which is DOPO-ITA.

34.6 g of DOPO-ITA, 10.4 g of solid neopentyl glycol (NPG), and 10.4 g of liquid NPG containing 10% water were added to the reaction vessel at once, heated to 100° C. to distill off the water; then, the temperature was raised to 180° C. and reacted for 1.5 hours to complete the pre-distillation, and then raised to 220° C. to react for 3 hours to complete the esterification process, obtaining poly-DOPO-ITA-pentanediol ester.

### (2) Preparation of Component A1:

By mass parts, 85 parts of carbon dioxide-based polyol, 12 parts of poly-DOPO-ITA-pentanediol ester, 3 parts of BDO, 0.4 parts of water, 0.7 parts of N-methylimidazole, 0.1 parts of bis(dimethylaminoethyl) ether, 0.5 parts of needle-like nano titanium dioxide, 0.2 parts of hindered phenol with carboxyl end group (3,5-di-tert-butyl, 4-hydroxybenzyl formic acid), 0.2 parts of dibutyltin dilaurate, 0.005 parts of strontium chloride, 0.025 parts of rhodium chloride, and 0.5 parts of foaming agent were added to the reaction vessel, stirred uniformly to obtain Component A1.

### (3) Preparation of Component B1:

By mass parts, under a vacuum of less than 0.06 MPa, 55 parts of carbon dioxide-based polyol were heated to 105° C. for dehydration; after dehydrating for 2 hours, 45 parts of MDI-50 were added at 80° C. and reacted for 3 hours to obtain a prepolymer, to which 0.02 parts of organic zinc and 0.01 parts of organic bismuth were added, stirred uniformly to obtain Component B1.

### (4) Preparation of the Product:

Component A1 and Component B1 were heated to 40° C. separately and then mixed at a mass ratio of 1:1. The mixture was stirred at a speed of 1500˜2000 r/min for 10˜15 s and then poured into a mold. It was cured in a 65° C. mold for 15 min to obtain the said carbon dioxide-based polyurethane elastomer.

### Comparative Example 2

### (1) Preparation of Poly-DOPO-ITA-Pentanediol Ester:

The procedure is the same as in Comparative Example 1 up to obtaining the white solid, which is DOPO-ITA.

### (2) Preparation of Component A2:

By mass parts, 85 parts of PTMG-1000, 12 parts of poly-DOPO-ITA-pentanediol ester, 3 parts of BDO, 0.4 parts of water, 0.7 parts of N-methylimidazole, 0.1 parts of bis(dimethylaminoethyl) ether, 0.5 parts of needle-like nano titanium dioxide, 0.2 parts of hindered phenol with carboxyl end group (3,5-di-tert-butyl, 4-hydroxybenzyl formic acid), 0.2 parts of dibutyltin dilaurate, 0.005 parts of strontium chloride, 0.025 parts of rhodium chloride, and 0.5 parts of foaming agent were added to the reaction vessel, stirred uniformly to obtain Component A2.

### (3) Preparation of Component B2:

By mass parts, under a vacuum of less than 0.06 MPa, 55 parts of PTMG-2000 were heated to 105° C. for dehydration; after dehydrating for 2 hours, 45 parts of MDI-50 were added at 80° C. and reacted for 3 hours to obtain a prepolymer, to which 0.02 parts of organic zinc and 0.01 parts of organic bismuth were added, and reacted at 80° C. for 3 hours, stirred uniformly to obtain Component B2.

### (4) Preparation of the Product:

Component A2 and Component B2 were heated to 40° C. separately and then mixed at a mass ratio of 1:1. The mixture was stirred at a speed of 1500˜2000 r/min for 10˜15 s and then poured into a mold. It was cured in a 65° C. mold for 15 min to obtain the said carbon dioxide-based polyurethane elastomer.

### Comparative Example 3

### (1) Preparation of Poly-DOPO-ITA-Pentanediol Ester:

The procedure is the same as in Comparative Example 1 up to obtaining the white solid, which is DOPO-ITA.

### (2) Preparation of Component A3:

By mass parts, 85 parts of PTMG-1000, 12 parts of poly-DOPO-ITA-pentanediol ester, 3 parts of BDO, 0.4 parts of water, 0.7 parts of N-methylimidazole, 0.1 parts of bis(dimethylaminoethyl) ether, 0.5 parts of needle-like nano titanium dioxide, 0.2 parts of hindered phenol with carboxyl end group (3,5-di-tert-butyl, 4-hydroxybenzyl formic acid), 0.2 parts of dibutyltin dilaurate, 0.005 parts of strontium chloride, 0.025 parts of rhodium chloride, and 0.5 parts of foaming agent were added to the reaction vessel, stirred uniformly to obtain Component A3.

### (3) Preparation of Component B3:

By mass parts, under a vacuum of less than 0.06 MPa, 55 parts of carbon dioxide-based polyol were heated to 105° C. for dehydration; after dehydrating for 2 hours, 45 parts of MDI-50 were added at 80° C. and reacted for 3 hours to obtain a prepolymer, to which 0.02 parts of organic zinc and 0.01 parts of organic bismuth were added, stirred uniformly to obtain Component B3.

### (4) Preparation of the Product:

Component A3 and Component B3 were heated to 40° C. separately and then mixed at a mass ratio of 1:1. The mixture was stirred at a speed of 1500˜2000 r/min for 10˜15 s and then poured into a mold. It was cured in a 65° C. mold for 15 min to obtain the said carbon dioxide-based polyurethane elastomer.

### Comparative Example 4

### (1) Preparation of Component A4:

By mass parts, 72 parts of PTMG-1000, 25 parts of carbon dioxide-based polyol, 3 parts of BDO, 0.4 parts of water, 0.7 parts of N-methylimidazole, 0.1 parts of bis(dimethylaminoethyl) ether, 0.5 parts of needle-like nano titanium dioxide, 0.2 parts of hindered phenol with carboxyl end group (3,5-di-tert-butyl, 4-hydroxybenzyl formic acid), 0.2 parts of dibutyltin dilaurate, 0.005 parts of strontium chloride,0.025 parts of rhodium chloride, and 0.5 parts of foaming agent were added to the reaction vessel, stirred uniformly to obtain Component A4.

### (2) Preparation of Component B4:

By mass parts, under a vacuum of less than 0.06 MPa, 55 parts of carbon dioxide-based polyol were heated to 105° C. for dehydration; after dehydrating for 2 hours, 45 parts of MDI-50 were added at 80° C. and reacted for 3 hours to obtain a prepolymer, to which 0.02 parts of organic zinc and 0.01 parts of organic bismuth were added, stirred uniformly to obtain Component B4.

### (4) Preparation of the Product:

Component A4 and Component B4 were heated to 40° C. separately and then mixed at a mass ratio of 1:1. The mixture was stirred at a speed of 1500˜2000 r/min for 10˜15 s and then poured into a mold. It was cured in a 65° C. mold for 15 min to obtain the said carbon dioxide-based polyurethane elastomer.

### Comparison Example 5

### (1) Preparation of Poly-DOPO-ITA-Pentanediol Ester:

21.6 g of DOPO was placed in 65 ml of toluene, heated to 85° C. and slowly stirred until dissolved, then 13 g of itaconic acid (ITA) was added, heated to 110° C. and reacted for 7 hours. After cooling the reaction mixture to room temperature, it was washed with tetrahydrofuran, filtered, and air-dried to obtain a white solid, which is DOPO-ITA.

34.6 g of DOPO-ITA, 10.4 g of solid neopentyl glycol (NPG), and 10.4 g of liquid NPG containing 10% water were added to the reaction vessel at once, heated to 100° C. to distill off the water; then, the temperature was raised to 180° C. to react for 1.5 hours to complete the pre-distillation, and then raised to 220° C. to react for 3 hours to complete the esterification process, obtaining poly-DOPO-ITA-pentanediol ester.

### (2) Preparation of Component A5:

By mass parts, 60 parts of PTMG-1000, 25 parts of carbon dioxide-based polyol, 12 parts of poly-DOPO-ITA-pentanediol ester, 3 parts of BDO, 0.4 parts of water, 0.7 parts of N-methylimidazole, 0.1 parts of bis(2-dimethylaminoethyl) ether, 0.5 parts of nano-titanium dioxide, 0.2 parts of hindered phenol with carboxylic end group (3,5-di-tert-butyl, 4-hydroxybenzoic acid), 0.2 parts of dibutyltin dilaurate, 0.005 parts of strontium chloride, 0.025 parts of rhodium chloride, and 0.5 parts of a foaming agent were added to the reaction vessel, stirred uniformly to obtain Component A5.

### (3) Preparation of Component B5:

By mass parts, under a vacuum of less than 0.06 MPa, 55 parts of carbon dioxide-based polyol were heated to 105° C. for dehydration; after dehydrating for 2 hours, 45 parts of MDI-50 were added at 80° C. and reacted for 3 hours to obtain a prepolymer, to which 0.02 parts of organic zinc and 0.01 parts of organic bismuth were added and stirred uniformly to obtain Component B5.

### (4) Product Preparation:

Components A5 and B5 were separately heated to 40° C. and then mixed in a 1:1 mass ratio, stirred at a speed of 1500˜2000 r/min for 10˜15 s, and then poured into a mold, cured in a 65° C. mold for 15 minutes to obtain the carbon dioxide-based polyurethane elastomer described.

### Comparison Example 6

### (1) Preparation of Component A6:

By mass parts, 72 parts of PTMG-1000, 25 parts of high-activity polyether polyol (molecular weight 6000, functionality 3), 3 parts of BDO, 0.4 parts of water, 0.7 parts of N-methylimidazole, 0.1 parts of bis(2-dimethylaminoethyl) ether, 0.5 parts of nano-titanium dioxide, 0.2 parts of hindered phenol with carboxylic end group (3,5-di-tert-butyl, 4-hydroxybenzoic acid), 0.2 parts of dibutyltin dilaurate, 0.005 parts of strontium chloride, 0.025 parts of rhodium chloride, and 0.5 parts of a foaming agent were added to the reaction vessel, stirred uniformly to obtain Component A6.

### (2) Preparation of Component B6:

By mass parts, under a vacuum of less than 0.06 MPa, 55 parts of PTMG-2000 were heated to 105° C. for dehydration; after dehydrating for 2 hours, 45 parts of MDI-50 were added at 80° C. and reacted for 3 hours to obtain a prepolymer, to which 0.02 parts of organic zinc and 0.01 parts of organic bismuth were added and stirred uniformly to obtain Component B6.

### (3) Product Preparation:

Components A6 and B6 were separately heated to 40° C. and then mixed in a 1:1 mass ratio, stirred at a speed of 1500˜2000 r/min for 10˜15 s, and then poured into a mold, cured in a 65° C. mold for 15 minutes to obtain the carbon dioxide-based polyurethane elastomer described.

### Embodiment Showing Effect 1

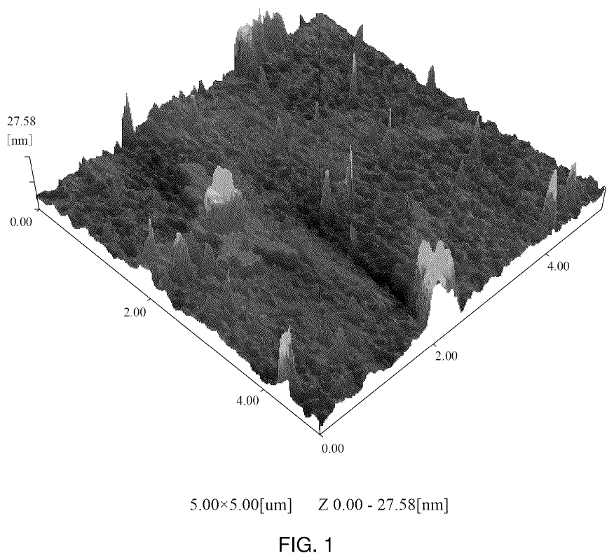

The polyurethane elastomer prepared in Example 1 and the product prepared in Comparison Example 6 (conventional PTMG-MDI type polyurethane) were tested by AFM, and the polyurethane elastomer prepared in Example 1 was tested by SEM, as shown in FIGS. 1-3.

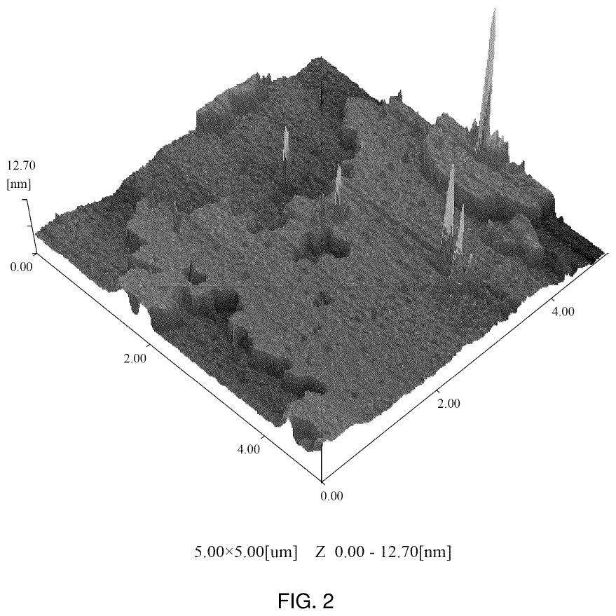

From FIGS. 1 and 2, it can be seen that compared to conventional PTMG-MDI type polyurethane, the average roughness Sa of the polyurethane elastomer obtained in this application changed from 17 nm to 3 nm, indicating a higher degree of microphase separation.

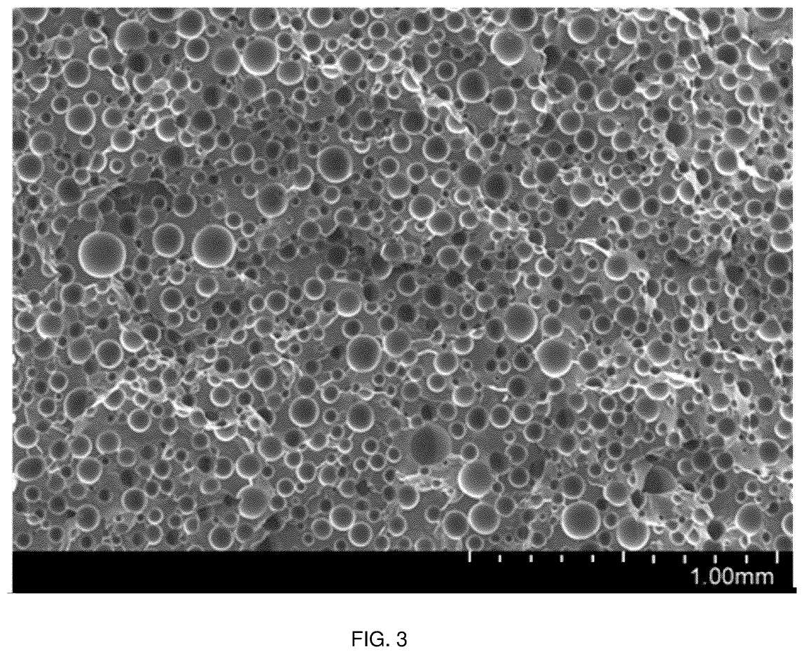

From FIG. 3, it can be seen that the polyurethane elastomer prepared by this invention has small and uniform bubbles, and the bubbles are closed cells.

### Embodiment Showing Effect 2

According to the corresponding standards, various performance tests were carried out on the polyurethane elastomers prepared in Examples 1-3 and the products prepared in Comparison Examples 1-6, and the test results are detailed in Table 1; among them, the density test refers to the standard GB/T1033.1-2008, tensile strength and elongation at break test refer to the standard GB/T1040.3-2006, static stiffness test refers to the standard TB/T3395.1, compression set test refers to the standard GB/T10653 (70° C., 22 h, 30% compression), 3 million cycles fatigue test refers to the standard TB/T3395.1 Appendix C (23±2° C. insulation for 24 h, cyclic load 20 KN˜80 KN, loading frequency 4 Hz+1 Hz, load cycle 3×10\hat{ }6 times), closed cell content test refers to the standard GBT10799-2008.

TABLE 1

| | | | Test results | | | |
|---|---|---|---|---|---|---|
| | | | | | | Comparative |
| Text items | | Indicator | Embodiment 1 | Embodiment 2 | Embodiment 3 | example 1 |
| Density/kg/m [symbol] | | / | 640 | 680 | 600 | 640 |
| Tensile | Before aging | ≥2.0 | 2.93 | 3.28 | 3.1 [symbol] | 2.55 |
| strength/MPa | After aging | ≥1.8 | 4.12 | 4. [symbol] 5 | 4.02 | 3.76 |
| Elongation | Before aging | ≥150 | 380 | 362 | 395 | 298 |
| at break/% | After aging | ≥120 | 435 | 395 | 425 | 368 |
| Compression permanent | | ≤5.0 | 4.0 | 4.2 | 4. [symbol] | 5.5 |
| deformation/% | | | | | | |
| Static stiffness/kN/mm | | 20 ± 1.5 | 19.7 | 21.0 | 20. [symbol] | 17.8 |
| Dynamic and static | | ≤1.35 | 1.19 | 1.23 | 1.20 | 1.30 |
| stiffness ratio | | | | | | |
| Load 3 million | Permanent | ≤10% | 7.8 | 9.2 | 8.8 | 9.8 |
| times fatigue | deformation rate 10% | | | | | |
| test | Staic stiffness | ≤20% | 9.3 | 13.5 | 14.2 | 20. [symbol] |
| | change rate/% | | | | | |

| | | | | |
|---|---|---|---|---|
| Closed hole rate/% | 92 | 90 | 91 | 88 |

| | | Test results | | | | |
|---|---|---|---|---|---|---|
| | | Comparative | Comparative | Comparative | Comparative | Comparative |
| Text items | | example 2 | example 3 | example 4 | example 5 | example 6 |
| Density/kg/m [symbol] | | 640 | 640 | 640 | 640 | 640 |
| Tensile | Before aging | 2.62 | 2.58 | 2.60 | 2.90 | 2.53 |
| strength/MPa | After aging | 3.83 | 3.80 | 3.05 | 3.93 | 3. [symbol] 0 |
| Elongation | Before aging | 247 | 306 | 306 | 372 | 309 |
| at break/% | After aging | 335 | 365 | 355 | 428 | 3 [symbol] 8 |
| Compression permanent | | 6.7 | 6.2 | 4.8 | 5.3 | 5.0 |
| deformation/% | | | | | | |
| Static stiffness/kN/mm | | 22.6 | 21.7 | 19.8 | 20.3 | 20.3 |
| Dynamic and static | | 1.30 | 1.28 | 1.37 | 1.22 | 1.38 |
| stiffness ratio | | | | | | |
| Load 3 million | Permanent | 12.2 | 12.3 | 11. [symbol] | 10.5 | 11.2 |
| times fatigue | deformation rate 10% | | | | | |
| test | Staic stiffness | 15.6 | 16.3 | 22.3 | 10.6 | 19.2 |
| | change rate/% | | | | | |

| | | | | | |
|---|---|---|---|---|---|
| Closed hole rate/% | 80 | 91 | 90 | 82 | 78 |

[symbol]

indicates data missing or illegible when filed

1. A carbon dioxide-based polyurethane elastomer with damping and anti-fatigue aging properties, characterized in that the polyurethane elastomer is obtained by mixing Component A and Component B in a mass ratio of 1:(0.95-1.10);
component A, by mass parts, includes: PTMG-1000 45˜60 parts, carbon dioxide-based polyol 25˜30 parts, poly-DOPO-ITA-pentanediol ester 10˜20 parts, BDO 3˜5 parts, water 0.3˜0.5 parts, N-methylimidazole 0.5˜0.8 parts, bis(2-dimethylaminoethyl) ether 0.1˜0.2 parts, needle-shaped nano-titanium dioxide 0.5 parts, hindered phenol with carboxylic end group 0.2˜0.5 parts, dibutyltin dilaurate 0.1˜0.3 parts, strontium chloride 0.005˜0.01 parts, rhodium chloride 0.02˜0.03 parts, foaming agent 0.2˜0.5 parts;
component B, by mass parts, includes: prepolymer, organic zinc, and organic bismuth, where the prepolymer is obtained by reacting 50˜55 parts of carbon dioxide-based polyol with 45˜50 parts of MDI-50 at 80˜90° C. for 2˜3 hours, organic zinc 0.01˜0.02 parts, organic bismuth 0.01˜0.02 parts.

2. The carbon dioxide-based polyurethane elastomer with damping and anti-fatigue aging properties according to claim 1, characterized in that the carbon dioxide-based polyol in components A and B has a molecular weight of 2000˜3000 and a functionality of 2.

3. The carbon dioxide-based polyurethane elastomer with damping and anti-fatigue aging properties according to claim 1, characterized in that the reaction formula for the poly-DOPO-ITA-pentanediol ester in component A is as follows:
first step chemical equation: 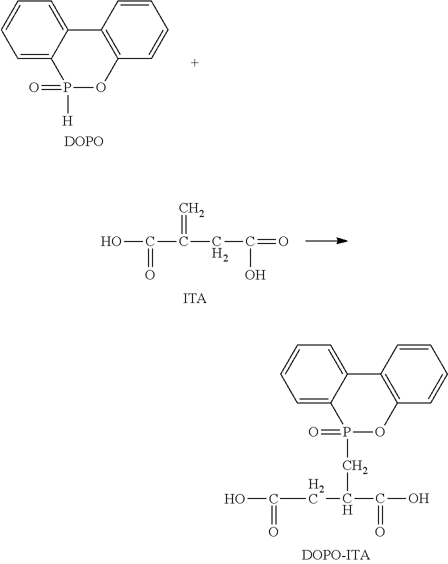
second step chemical equation:

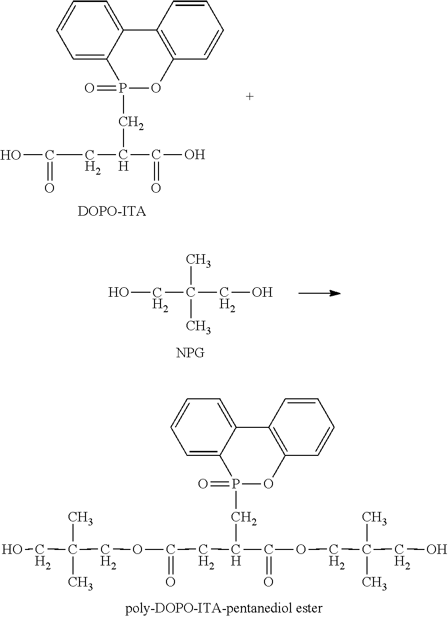

4. The carbon dioxide-based polyurethane elastomer with damping and anti-fatigue aging properties according to claim 3, characterized by comprising the following steps:
(1) placing DOPO in toluene, heating to 85° C., and stirring slowly until dissolved; then adding itaconic acid (ITA), heating to 110° C., and reacting for 7 hours; subsequently cooling to room temperature and filtering to obtain a white solid, which is DOPO-ITA;
(2) adding DOPO-ITA, solid neopentyl glycol, and liquid NPG containing 10% water to the reaction vessel, heating to 100° C. to distill off the water; then raising the temperature to 180° C. to react for 1.5 hours to complete the pre-distillation, and further raising to 220° C. to react for 3 hours to complete the esterification process, obtaining poly-DOPO-ITA-pentanediol ester.

5. The carbon dioxide-based polyurethane elastomer with damping and anti-fatigue aging properties according to claim 4, characterized in that, in step (1), 21˜22 g of DOPO is placed in 60˜70 mL of toluene, heated to 85° C. and slowly stirred until dissolved, then 12˜14 g of itaconic acid is added;
in step (2), 34˜35 g of DOPO-ITA, 10˜11 g of solid neopentyl glycol, and 10˜11 g of liquid neopentyl glycol containing 10% water are added.

6. The carbon dioxide-based polyurethane elastomer with damping and anti-fatigue aging properties according to claim 1, characterized in that the needle-shaped nano-titanium dioxide in Component A has a diameter of 10-100 nm and an aspect ratio of 30-100.

7. The carbon dioxide-based polyurethane elastomer with damping and anti-fatigue aging properties according to claim 1, characterized in that the hindered phenol with carboxylic end group in component A is selected from any one of 3,5-di-tert-butyl, 4-hydroxybenzoic acid, 3,5-di-tert-butyl, 4-hydroxyphenylpropionic acid, or 3,5-di-tert-butyl, 4-hydroxyphenylvaleric acid.

8. The carbon dioxide-based polyurethane elastomer with damping and anti-fatigue aging properties according to claim 1, characterized in that the foaming agent in Component A is water-soluble silicone oil.

9. A method for preparing the carbon dioxide-based polyurethane elastomer with damping and anti-fatigue aging properties according to claim 1, characterized in that the method includes the following steps:
(1) preparing poly-DOPO-ITA-pentanediol ester:
placing 21-22 g of DOPO in 60-70 mL of toluene, heating to 85° C., and slowly stirring until dissolved, then adding 12-14 g of itaconic acid, heating to 110° C., and reacting for 7 hours, cooling to room temperature, and washing with tetrahydrofuran, then filtering and air-drying to obtain DOPO-ITA;
adding 34-35 g of DOPO-ITA, 10-11 g of solid neopentyl glycol, and 10-11 g of liquid NPG containing 10% water to the reaction vessel at once, heating to 100° C. to distil off the water; then, raising the temperature to 180° C. to react for 1.5 hours to complete the pre-distillation, and then raising to 220° C. to react for 3 hours to complete the esterification process, obtaining poly-DOPO-ITA-pentanediol ester;
(2) preparing component A:
adding PTMG-1000, carbon dioxide-based polyol, poly-DOPO-ITA-pentanediol ester, BDO, water, N-methylimidazole, bis(2-dimethylaminoethyl) ether, needle-shaped nano-titanium dioxide, hindered phenol with carboxylic end group, dibutyltin dilaurate, strontium chloride, rhodium chloride, and foaming agent to the reaction vessel in proportion, stirring uniformly to obtain component A;
(3) preparing component B:
heating carbon dioxide-based polyol to 105° C. for dehydration under a vacuum of less than 0.06 MPa; after dehydrating for 2 hours, adding MDI-50 and reacting at 80-90° C. for 2-3 hours to obtain a prepolymer, to which organic zinc and organic bismuth are added and stirred uniformly to obtain component B;
(4) preparing the carbon dioxide-based polyurethane elastomer with damping and anti-fatigue aging properties:
heating component A and component B separately to 40° C. and then mixing in a mass ratio of 1:(0.95-1.10), stirring at a speed of 1500-2000 r/min for 10-15 s, and then pouring into a mold, curing in a 65° C. mold for 12-15 minutes to obtain the carbon dioxide-based polyurethane elastomer.
